(19) United States
(12) Patent Application Publication
(10) Pub. No.: US 2025/0162004 A1
(43) Pub. Date: May 22, 2025

(54) CONTAINER WASHING SYSTEM AND METHOD

(71) Applicants: Jennifer Boyd, Rotunda West, FL (US); Clayton Boyd, Rotonda West, FL (US)

(72) Inventors: Jennifer Boyd, Rotunda West, FL (US); Clayton Boyd, Rotonda West, FL (US)

(21) Appl. No.: 18/812,502

(22) Filed: Aug. 22, 2024

Related U.S. Application Data
(63) Continuation of application No. 18/105,808, filed on Feb. 4, 2023, now abandoned.
(60) Provisional application No. 63/306,760, filed on Feb. 4, 2022.

(51) Int. Cl. B08B 9/34; B08B 9/08

(52) U.S. Cl. CPC B08B 9/34; B08B 9/0813; B08B 2209/08

(57) ABSTRACT

Disclosed herein are various embodiments of container washing systems and methods. The exemplary systems may include a foot valve, the foot valve having an input for a fluid, a tray having a grate, the grate configured to support the container; and a rotatable assembly having one or more nozzles, wherein actuation of the foot valve opens a fluid path from the foot valve to the nozzles, such that a fluid may be sprayed above the tray and into the interior of the container.

### BACKGROUND

### Field

This invention is generally related to container washing systems and methods, and more particularly to a system and method for operating a washer for a container, such as a trash can.

### Background

Container washing systems and methods in the past have suffered from the lack of an efficient and cost effective system and method for washing containers, such as cylindrical trash cans. Therefore, there is a need for a new and improved system and method for operating a washer for a container, such as a washer for cylindrical trash cans.

### SUMMARY

Disclosed herein is a new and improved container washing system and method. In accordance with one aspect of the approach, a container washing system may include a foot valve, the foot valve having an input for a fluid, a tray having a grate, the grate configured to support the container; and a rotatable assembly having one or more nozzles, wherein actuation of the foot valve opens a fluid path from the foot valve to the nozzles, such that a fluid may be sprayed above the tray and into the interior of the container.

In accordance with another aspect of the approach, a method for cleaning containers, the method may include the steps of securing a tray to a solid surface; placing a foot valve near the tray, including placing the foot valve in close enough proximity to tray to allow an operator to conveniently operate the foot valve while in arms reach of the tray; placing the container above tray with an open end of the container above the tray, including lifting the container from the solid surface, inverting the container, and setting the container on a grate above the tray; and activating the foot valve releasing a fluid spray into the container.

Other systems, methods, aspects, features, embodiments and advantages of the container washing system and method are disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

It is to be understood that the drawings are solely for the purpose of illustration. Furthermore, the components in the figures are not necessarily to scale, emphasis instead being placed upon illustrating the principles of the system disclosed herein. In the figures, like reference numerals designate corresponding parts throughout the different views.

FIG. 1 is a view of an exemplary washing apparatus, including a fluid pump, a T-fitting, a spray gun, a foot valve, and a wash assembly.

FIG. 2 is a view of the wash assembly of FIG. 1 and a container, with the wash assembly including a tray.

FIG. 3 is a second view of the tray of FIG. 2 including a rotatable assembly.

FIG. 4 is a view of the rotatable assembly of FIG. 3, including a base, a rotatable mount, a wand, and a nozzle.

FIG. 5 is a flow diagram illustrating an exemplary method for washing containers.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

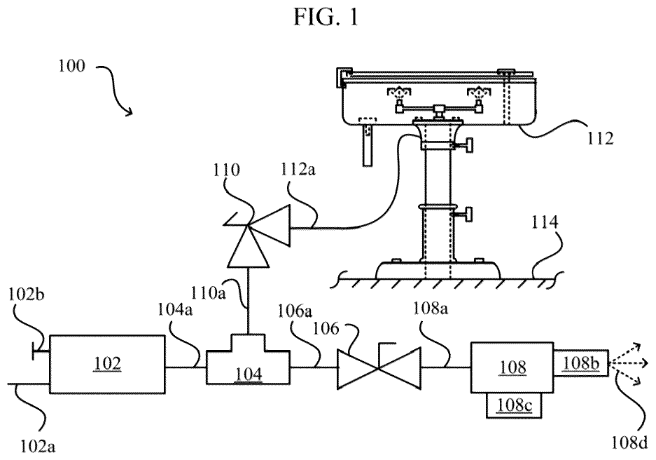

FIG. 1 shows an exemplary washing apparatus 100. The apparatus 100 may include a fluid pump 102, an power supply 102a, a fluid supply 102b, a fluid line 104a, a T-fitting 104, fluid line 106a, a hand valve 106, a fluid line 108a, a spray gun 108, a fluid line 110a, a foot valve 110, a fluid line 112a, and a wash assembly 112 on a solid surface 114.

Fluid pump 102 may be, but is not limited to, a 1.7 gallons per minute pump capable of pressurizing fluid to 1200 pounds per square inch. Power supply 102a may be 120 volts and may include a ground fault circuit protector with a reset.

The spray gun 108 may include a gun nozzle 108b, and a gun trigger 108c. When the foot valve 110 is not activated, a first fluid path may exist between the fluid supply 102b and the spray gun 108. Activation of the gun trigger 108c may allow for a spray 108d, to be emitted from the gun nozzle 108b. The gun nozzle 108b may be adjustable and/or easily interchangeable to allow a variety of spray patterns to be emitted from the gun nozzle 108b.

Activation of the foot valve 110, for example through compression of a pedal (not shown) incorporated into the foot valve 110, may establish a second fluid path from the fluid supply 102b to the wash assembly 112. Stainless steel, aluminum, and acrylonitrile butadiene styrene polymer/plastic material to compose the tray may be used to construct most of the components of the wash assembly 112.

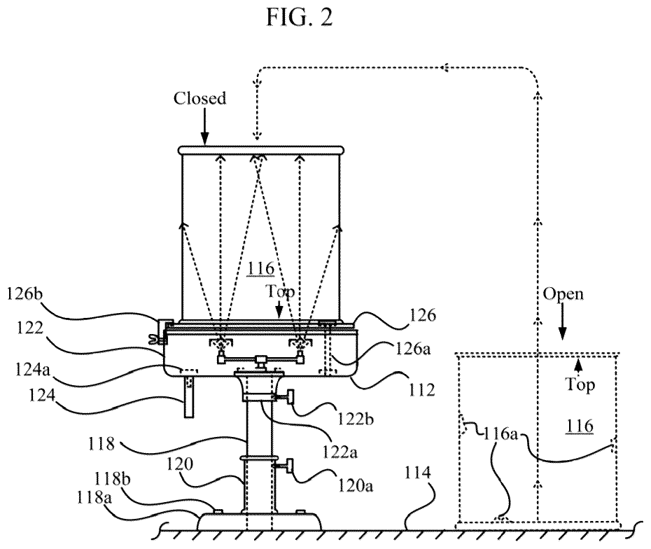

FIG. 2 is a view of the wash assembly 112 of FIG. 1 and a container 116. As shown in FIG. 2 the wash assembly 112 may include a pipe support 118, a pipe support base 118a, one or more pipe support base fasteners 118b, a base support sleeve 120, a base fastener 120a, a tray 122, a tray support 122a, one or more tray support fasteners 122b, a drain 124, a filter 124a, a grate 126, a grate support 126a, and a grate clip 126b. The container 116, may be a trash can, and may include crud 116a. The washing apparatus 100 allows for such crud 116a, to be removed from the container 116, and allows for said crud 116a to be dissolved and discharged from drain 124, and/or to be left for removal from tray 122. Drain 124 may be piped to floor drain, or may be allowed to discharge into some other suitable disposal vessel (not shown).

The spray gun 108 may be used to clean the exterior of container 116, and to clean, pre-clean, or to complete cleaning the interior of container 116. The triggered adjustable spray nozzle (not shown) that may be included with the spray gun 108 may allow the first fluid path to be extended from the fluid supply 102b and the gun nozzle 108b. Fluid line 106a may be, but is not limited to, a 25-foot line capable of containing fluid at pressures generated by the fluid pump 102.

The grate 126 may be stainless steel. The grate 126 may be releasably secured to the tray using the grate clip 126b. Loosening the grate clip 126b may allow the grate to pivoted about the grate support 126a, thus allowing access to the tray 122 for cleaning of the tray 122. The height of the tray 122 may be adjustable, for example, by adjusting the position of the base fastener 120a.

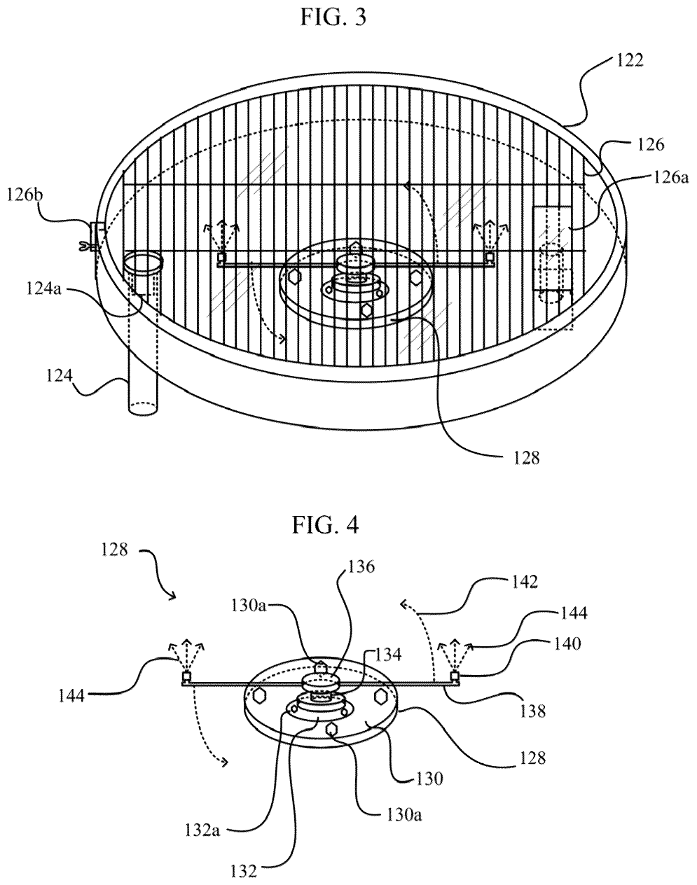

FIG. 3 is a second view of the tray 122 of FIG. 2 showing the tray 122 may include a rotatable assembly 128. Grate 126 may provide both a support for the container 116, as illustrated in FIG. 2, and may provide protection for the operator from the moving parts of the wash assembly 112, such as moving parts associated with the rotatable assembly 128. Grate 126 may be stainless steel.

FIG. 4 is a view of the rotatable assembly 128 of FIG. 3, showing the rotatable assembly 128 may include a base plate 130, one or more base fasteners 130a, a rotator mount 132, one or more rotator mount fasteners 132a, a riser 134, a wand mount 136, one or more wands 138, and one or more rotatable nozzles 140. In FIG. 4, arrows 142 are used to illustrate fluid spray 144 that may be expelled from the rotatable nozzles 140.

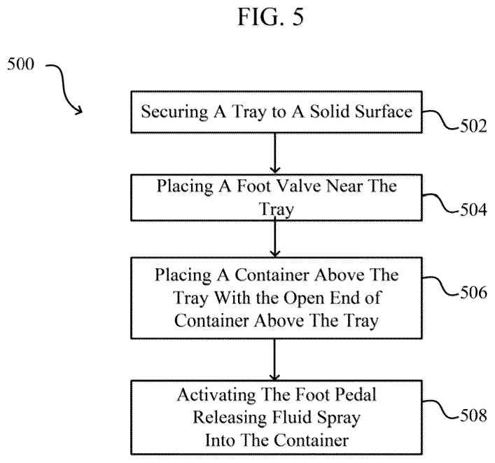

FIG. 5 is a flow diagram illustrating an exemplary method for washing containers 500. Method 500 may include the steps of securing tray 502, placing foot pedal near tray 504, placing container above tray with open end of container above the tray 506, and activating foot pedal releasing fluid spray into container 508.

The step of securing the tray 502 may include, but is not limited to, securing the tray, for example tray 122, to the solid surface 114, such as the ground or a base plate (not shown). The tray may be secured to the solid surface using, for example but not limited to, the pipe support 118, the pipe support base 118a, pipe support base fasteners 118b, the base support sleeve 120, the base fastener 120a, the tray support 122a, and the tray support fasteners 122b.

A soiled container, for example container 116, may be placed near the tray, for example container 116 may be placed on the solid surface 114 near the tray 122, such as illustrated in FIG. 2 in dashed lines. While on the solid surface 114, the spray gun 108 may be used to clean the exterior of container 116, and to clean and/or pre-clean the interior of container 116.

The step of placing foot pedal near tray 504, may include, but is not limited to, placing foot valve 110 in close enough proximity to tray 504, for example within three feet, to allow an operator to conveniently operate the foot valve 110 while in arms reach of tray 504.

The step of placing container above tray with open end of container above the tray 506, may include, but is not limited to, lifting container 116 from the solid surface 114, inverting the container 116, and setting the container above the tray, for example upon the grate 126, as illustrated in FIG. 2.

The step of activating foot pedal releasing fluid spray into container 508, may include, but is not limited to, depressing a pedal (not shown) associated with the foot valve 110. Depressing the pedal may establish the second fluid path from the fluid supply 102b and the rotatable nozzles 140. The fluid may then be discharged from the rotatable nozzles 140 into the interior of the container 116.

This application incorporates by reference the teachings of the following U.S. patent applications: U.S. patent application Ser. No. 15/992,155, filed 29 May 2018, to Boyd, et al; and U.S. Provisional Patent Application No. 63/306,760, filed 4 Feb. 2022, to Boyd, et al.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings. All such modifications and variations are intended to be included herein within the scope of this disclosure and protected by the following claims.

1. A container washing system, comprising:
a foot valve, the foot valve having an input for a fluid;
a tray having a grate, the grate configured to support the container; and
a rotatable assembly having one or more nozzles,
wherein actuation of the foot valve opens a fluid path from the foot valve to the nozzles,
such that a fluid may be sprayed above the tray and into the interior of the container.

2. The container washer system of claim 1, where the rotatable assembly is beneath the grate.

3. The container washer system of claim 1, where the height of the tray is adjustable.

4. A method of washing containers, the method including the steps of:
securing a tray to a solid surface with a single pipe support such that a height of the tray is adjustable above the solid surface;
placing a foot valve near the tray, including placing the foot valve in close enough proximity to the tray to allow an operator to conveniently operate the foot valve while in arms reach of the tray;
placing the container above the tray with an open end of the container above the tray, including lifting the container from the solid surface, inverting the container, and setting the container on a grate above the tray;
activating the foot valve releasing a fluid spray into the container;
deactivating the foot valve;
moving the container from above the tray and placing a closed end of the container on a solid surface; and
using a spray gun to clean the interior of the container.

5. The method of claim 4, wherein the step of placing the foot valve near the tray, includes placing the foot valve within three feet of the tray.
